(19) United States
(12) Patent Application Publication
(10) Pub. No.: US 2023/0394199 A1
(43) Pub. Date: Dec. 7, 2023

(54) METHOD AND CONFIGURATION SYSTEM FOR CONFIGURING A CONTROL DEVICE FOR A TECHNICAL SYSTEM

(71) Applicant: Siemens Aktiengesellschaft, München (DE)

(72) Inventors: Steffen Udluft, Eichenau (DE); Simon Fehrer, München (DE); Michel Tokic, Tettnang (DE); Daniel Hein, München (DE)

(21) Appl. No.: 18/032,330

(22) PCT Filed: Sep. 10, 2021
(86) PCT No.: PCT/EP2021/074918

§ 371 Date: Apr. 17, 2023

(30) Foreign Application Priority Data
Oct. 20, 2020 (EP) 20202826.2

(51) Int. Cl. G06F 30/27; G06F 30/25

(52) U.S. Cl. CPC G06F 30/27; G06F 30/25; G06F 2111/06

(57) ABSTRACT

In order to configure a control device, a predefined default configuration data set is read in. Furthermore, a deviation from the default configuration data set as well as a control performance are determined for each of a large number of generated test configuration data sets. In addition, a Pareto optimization is performed for the large number of test configuration data sets, wherein the deviation as well as the control performance are used as Pareto objective criteria. A configuration data set resulting from the Pareto optimization is then selected to configure the control device.

### CROSS-REFERENCE TO RELATED APPLICATIONS

This application claims priority to PCT Application No. PCT/EP2021/074918, having a filing date of Sep. 10, 2021, which claims priority to EP Application No.20202826.2, having a filing date of Oct. 20, 2020, the entire contents both of which are hereby incorporated by reference.

### FIELD OF TECHNOLOGY

The following relates to a method and configuration system for configuring a control device for a technical system.

### BACKGROUND

Complex technical systems, such as traffic signal systems, turbines, manufacturing systems, robots or motors, usually require a complex configuration for productive operation in order to optimize the performance of the technical system in a targeted manner. The performance to be optimized may pertain, for example, to a capacity, a yield, a resource requirement, a degree of efficiency, a level of pollutant emission, stability, wear, and/or other target parameters of the technical system.

Current control devices of technical systems often use data-driven machine learning methods for optimizing their configuration. By means of such learning methods, a control device can be trained to determine, based on current operating data from the technical system, those control actions that specifically cause a required or otherwise optimal behavior of the technical system. For these purposes, a plurality of known machine learning methods are available, in particular methods of reinforcement learning.

However, a configuration found by a performance-driven optimization method in many cases still needs to be checked or validated with regard to its safety and/or for user acceptance.

The publication WO2016/000851A1 discloses a control optimization method for a technical system, in which effects of configuration interventions can be determined interactively by means of a simulation. However, such an interactive validation often requires a relatively high manual effort.

### SUMMARY

An aspect relates to specify a method and a configuration system for configuring a control device for a technical system, which enable the safety and/or user acceptance of a configuration to be improved with less effort.

In order to configure a control device for a technical system, a predefined default configuration data set for the control device is read in. In this context, the technical system can be, in particular, a traffic signal system, a turbine, a manufacturing system, a robot, a motor, another machine, another device, or another system. Furthermore, a plurality of test configuration data sets are generated. According to embodiments of the invention, a deviation value quantifying a deviation from the default configuration data set, and a performance value quantifying a performance for controlling the technical system on the basis of the respective test configuration data set, are determined for a respective test configuration data set. In addition, Pareto optimization is performed for the plurality of test configuration data sets, wherein the deviation and performance are used as Pareto objective criteria. Pareto optimization is known to be a multi-criteria optimization method with several objective criteria, which are also referred to as Pareto objective criteria here and in the following. A configuration data set resulting from the Pareto optimization is then selected for configuring the control device.

A configuration system, a computer program product (non-transitory computer readable storage medium having instructions, which when executed by a processor, perform actions), and a computer-readable, non-volatile, storage medium are provided for carrying out the method according to embodiments of the invention.

The method according to embodiments of the invention as well as the configuration system according to embodiments of the invention can be executed or implemented, for example, by means of one or more computers, processors, application-specific integrated circuits (ASIC), digital signal processors (DSP) and/or so-called field programmable gate arrays (FPGA).

Insofar as Pareto optimization takes into account the deviation from the default configuration data set and thus, in a sense, a similarity to a default control behavior, a configuration can be determined that is generally both performant and has high user acceptance. Pareto optimization also facilitates the exclusion of non-optimal configurations.

According to an advantageous embodiment of the invention, data elements of the default configuration data set may be selected. The test configuration data sets can then be generated based on the default configuration data set, wherein any change to the selected data elements is suppressed. In particular, the selected data elements can be transferred unchanged to a respective default configuration data set, while the other data elements of the default configuration data set are varied. This facilitates the exclusion of impermissible or undesirable changes to the configuration, or the ensuring of compliance with boundary conditions.

Advantageously, Pareto optimization can identify a Pareto front within the generated test configuration data sets. A configuration data set can then be selected from the Pareto front to configure the control device. A Pareto front is also understood as a set of configuration data sets whose distance to a mathematically exact Pareto optimum, for example, falls below a given threshold. By restricting the selection to a Pareto front, a space of possible configurations is usually considerably limited, wherein non-optimal configurations in particular are omitted. The selection as well as, if necessary, a subsequent optimization of configuration data sets of the Pareto front are thus considerably simplified.

In particular, a genetic optimization method, a method of genetic programming, a gradient-based optimization method, a stochastic gradient method, a particle swarm optimization method, a Metropolis optimization method, and/or another machine learning method can be used to perform the Pareto optimization. A plurality of efficient default routines are available for the optimization methods mentioned.

Advantageously, new configuration data sets generated when performing the Pareto optimization can be used as test configuration data sets. The new configuration data sets can be generated as part of performance-driven optimization. In this way, the generation of the test configuration data sets can be preferentially driven towards performant configurations.

According to an advantageous embodiment of the invention, for determining the performance value for a respective test configuration data set, the technical system and/or a simulation model of the technical system may be controlled based on the respective test configuration data set, wherein a resulting performance of the technical system is measured. A surrogate model of the technical system can be used as a simulation model, which requires fewer computing resources than a full simulation.

According to a preferred embodiment of the invention, for determining the performance value for a respective test configuration data set, a deviation of a response behavior of the control device, configured with the respective test configuration data set, from a response behavior of the control device, configured with a performance-optimized configuration data set, may be determined. The performance-optimized configuration data set can be used as a kind of benchmark for achievable performance and can be determined using a method of reinforcement learning. This type of method is often also referred to as reinforcement learning.

According to a further embodiment of the invention, for determining the deviation value for a respective test configuration data set, a deviation of a component representation of the respective test configuration data set from a component representation of the default configuration data set may be determined. The component representation can be e.g. a vector representation. In the case of genetically encoded configuration data sets, the deviation can be expressed by a number of differences in the genomes of the configuration data sets in question, that is, by a kind of deviation in the genotype of the configuration data sets. In particular, the deviation can be expressed by a minimum number of operations needed to convert one of the configuration data sets to the other.

Furthermore, in order to determine the deviation value for a respective test configuration data set, a deviation of a response behavior of the control device, configured with the respective test configuration data set, from a response behavior of the control device, configured with the default configuration data set, may be determined. Such a deviation can be understood as a kind of deviation in the phenotype of the configuration data sets.

### BRIEF DESCRIPTION

Some of the embodiments will be described in detail, with reference to the following figures, wherein like designations denote like members, wherein:

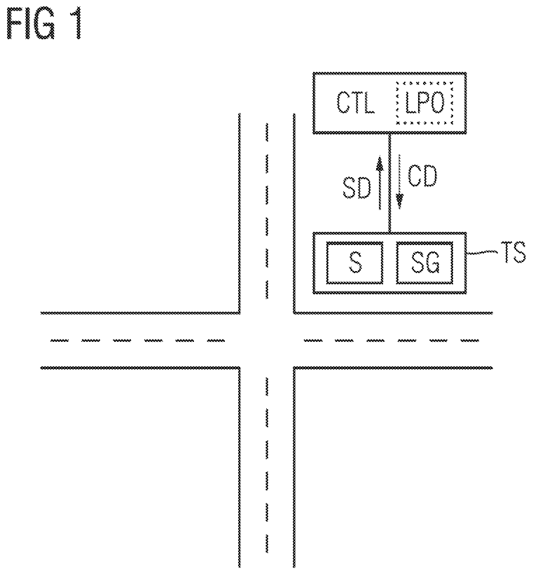

FIG. 1 shows a traffic signal system with a control device; and

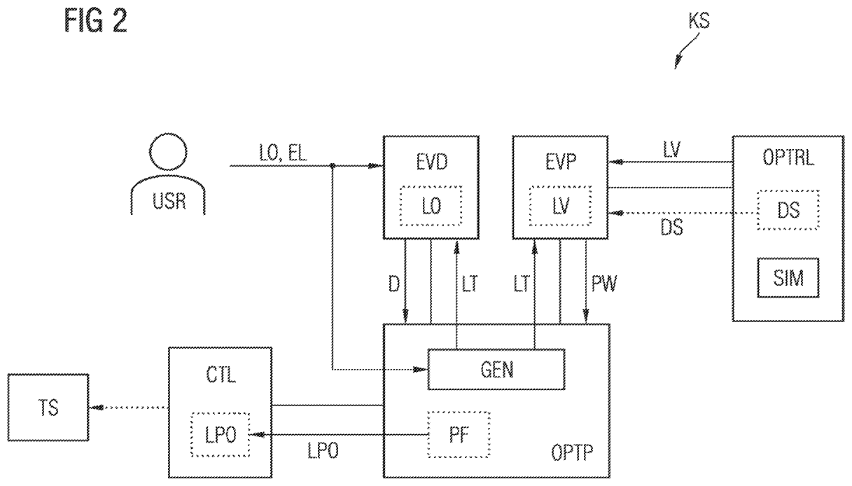

FIG. 2 shows a configuration system according to the invention during configuration of a control device.

### DETAILED DESCRIPTION

FIG. 1 shows a schematic representation of a traffic signal system arranged at a road intersection as a technical system TS, which is coupled to a system controller CTL as a control device for the traffic signal system TS. The traffic signal system TS has a signal group SG, which can comprise one or more traffic lights, and a sensor system S for continuously measuring and/or recording operating parameters of the traffic signal system TS and local traffic data.

Alternatively, the technical system TS may also include a turbine, a manufacturing system, a robot, a motor, a 3D printer, or another machine, device, or system. The method according to embodiments of the invention for configuring the control device CTL can be applied in an analogous manner in these cases.

The system controller CTL is computer-configurable and can be implemented as part of the traffic signal system TS or completely or partially external to the traffic signal system TS. The system controller CTL is used for traffic-dependent control of the traffic signal system TS.

The system controller CTL is to be configured in such a way that the technical system TS is controlled in an optimized manner. Control of a technical system, here TS, is also understood to include its regulation as well as the output and use of control-relevant data and control signals, i.e. data and control signals that contribute to the targeted influencing of the technical system.

In the present exemplary embodiment, the system controller CTL is to be configured by means of machine learning methods in such a way that control of signal phases or other traffic control actions of the signal group SG or the light sign system TS is optimized depending on the recorded operating parameters and traffic data. Here and in the following, the term “optimization” is also understood to mean an approach to an optimum. In particular, it is intended that waiting times for vehicles be reduced and/or a throughput rate of vehicles be increased. Alternatively or additionally, other variables contributing to the performance of the light sign system TS or the system controller CTL can be optimized.

A control behavior of the system controller CTL is defined by its configuration. For optimized configuration of the system controller CTL, an optimized configuration data set LPO is transmitted to the system controller CTL, by which a plurality of setting parameters of the system controller CTL are specifically set. A control behavior of the system controller CTL set by this is often also referred to as a policy or response behavior. The optimized configuration data set LPO is determined by a method according to embodiments of the invention.

Such a configuration data set defining the control behavior of the system controller CTL can be represented by different data structures. Thus, a respective configuration data set may comprise a plurality of parameters, variables or action selection rules, a program code, a syntax tree, a mathematical expression, a classifier, neural weights, a PID controller (PID: Proportional Integral Derivative), another controller, and/or other configuration description data.

The sensor system S transmits the continuously recorded traffic data and operating parameters of the light sign system TS in the form of sensor data SD to the system controller CTL. The operating parameters may include information about operating states of the light sign system TS, e.g. about a current traffic light phase, about switching states, about control states, about control actions, about system states and/or about system properties. In particular, the traffic data may include information about a number and/or speed of vehicles, about a current traffic load and/or about a local pollution load.

Depending on the transmitted sensor data SD, control data CD are generated by the system controller CTL and are transmitted to the light sign system TS by the system controller CTL for optimized control of the light sign system TS. The control data CD are generated according to the policy of the system controller CTL configured by the optimized configuration data set LPO.

FIG. 2 shows a schematic representation of a configuration system KS according to embodiments of the invention during configuration of a control device CTL. Insofar as the same or corresponding reference signs are used in FIG. 2 as in FIG. 1, these reference signs designate the same or corresponding entities, which can be implemented or designed in particular as described above.

The control device CTL may form part of the configuration system KS or may be wholly or partially external to the configuration system KS. The configuration system KS and/or the control device CTL has/have one or more processors for carrying out the method according to embodiments of the invention and one or more memories for storing data to be processed. As already mentioned above, the control device CTL is to be configured by means of the configuration system KS in such a way that a technical system TS, e.g. a traffic signal system, is controlled in an optimized manner.

The starting point for the configuration is a default configuration data set L0, which is entered by a user USR of the configuration system KS or read in from a database. The default configuration data set L0 defines a default configuration of the control device CTL, by which the control device CTL reacts to a sensor system and controls the technical system TS depending on it. The default control behavior effected by the default configuration is generally usable and validated, but not yet optimal.

Furthermore, a specification EL about data elements of the default configuration data set L0 to be kept constant during the optimization of the configuration is read in by the user USR or from a database. The remaining data elements of the default configuration data set L0 can therefore be changed during optimization. In this way, impermissible or untrusted changes to the control behavior compared to the default configuration can be ruled out. This enables a duration of amber phases or a minimum duration for green phases or red phases to be kept constant in a light sign system as a technical system TS.

The configurations achievable by varying the data elements of the default configuration data set L0 that are not to be kept constant form the configuration space available for optimization.

The default configuration data set L0 and the specification EL are transmitted to a deviation evaluator EVD of the configuration system KS for initialization of the deviation evaluator EVD.

The deviation evaluator EVD is used to quantify, for a respective configuration data set, a deviation of the configuration given thereby, or the response behavior defined thereby, from the default configuration. Using the respective deviation, in particular a respective similarity to the default configuration can be expressed. This similarity can be understood as a kind of familiarity of the given configuration or the resulting control behavior. A high familiarity of the control behavior usually also increases its user acceptance and/or its safety. In the case of a traffic signal system as a technical system TS, a configuration similar to the default configuration is more likely to meet the expectations of road users than a less similar configuration.

Furthermore, a first optimizer OPTRL determines a performance-optimized configuration data set LV for the control device CTL. For this purpose, the first optimizer OPTRL has a simulation model SIM, which models and simulates the technical system TS with respect to its control. In the case of a light sign system as a technical system TS, the simulation model SIM simulates the road intersection in question and the traffic flows. The performance-optimized configuration data set LV is determined using a method of reinforcement learning based on the simulation model SIM.

The performance with respect to which the optimization is performed may pertain to, in particular, a capacity, a yield, a speed, a time requirement, a running time, a resource requirement, a degree of efficiency or precision, a level of stability or wear, a lifetime, a pollutant emission, a traffic throughput and/or a failure rate of the technical system TS. A plurality of well-known and efficient methods of reinforcement learning are available to perform this kind of performance-driven optimization.

Optimization by the first optimizer OPTRL is performed without considering any deviation from the default configuration data set L0, so the performance-optimized configuration data set LV may result in a completely unfamiliar control behavior and may be outside the permissible configuration space. The performance-optimized configuration data set LV can therefore in most cases not be used directly for configuring the control device CTL, but in the context of embodiments of the invention forms a benchmark for the generally achievable performance of the control device CTL or the technical system TS.

The method of reinforcement learning executed by the first optimizer OPTRL generates a data set DS comprising achieved system states of the technical system TS, executed control actions, subsequent states achieved thereby, and resulting rewards quantifying a success of the control action in terms of reinforcement learning.

The performance-optimized configuration data set LV as well as the data set DS are transmitted from the first optimizer OPTRL to a performance evaluator EVP of the configuration system KS.

The performance evaluator EVP is used to quantify, for a respective configuration data set, a performance of the technical system TS controlled on the basis of this configuration data set. In this way, a kind of control performance of the control device CTL configured thereby is evaluated. The performance-optimized configuration data set LV is used by the performance evaluator EVP as a benchmark for the achievable performance.

The configuration system KS further comprises a second optimizer, which is designed as a Pareto optimizer OPTP for performing a Pareto optimization. A Pareto optimization is a multi-criteria optimization in which several different objective criteria, so-called Pareto objective criteria, are considered independently. As a result of the Pareto optimization, a so-called Pareto front PF is determined. A Pareto front is often also called a Pareto set. A Pareto front, here PF, consists of those solutions to a multi-criteria optimization problem where one objective criterion cannot be improved without worsening another objective criterion. So, in a sense, a Pareto front forms a set of optimal compromises. In particular, solutions not included in the Pareto front PF can still be improved with respect to at least one objective criterion. Consequently, a restriction to the Pareto front PF eliminates a plurality of solutions that are certainly not optimal. Since a Pareto front usually covers only a very small part of a possible solution space, a restriction to a Pareto front considerably reduces a subsequent selection or further optimization effort.

According to embodiments of the invention, the Pareto optimizer OPTP determines a Pareto front PF with respect to the Pareto objective criteria of deviation from the default configuration as well as performance. The optimization thereby moves towards greater performance and smaller deviation, i.e. greater familiarity of the control behavior. For such Pareto optimizations, a plurality of default routines are available, in particular machine learning methods.

In the present exemplary embodiment, a method of genetic programming is used for Pareto optimization. In the context of genetic programming, the permissible configuration space is searched for optimized configurations. For this purpose, a generator GEN of the Pareto optimizer OPTP generates a large number of new configuration data sets, which are used as test configuration data sets LT. To initialize the generator GEN, the default configuration data set L0 and the specification EL about the data elements of the default configuration data set L0 to be kept constant are transmitted to the generator GEN. The test configuration data sets LT are generated by the generator GEN from the default configuration data set L0, wherein the data elements of the default configuration data set L0 identified by the specification EL are not changed, while its remaining data elements are varied in the permissible configuration space.

The generated test configuration data sets LT are transmitted from the generator GEN to the performance evaluator EVP as well as to the deviation evaluator EVD. The performance evaluator EVP determines for a respective test configuration data set LT, as already indicated above, a respective performance value PW which quantifies a performance of the technical system TS controlled on the basis of this test configuration data set LT. For this purpose, in the present exemplary embodiment, a deviation of a response behavior of the control device CTL, configured with the respective test configuration data set LT, from a response behavior of the control device CTL, configured with the performance-optimized configuration data set LV, is determined. Here, the system states contained in the data set DS are used as representative support points for which the response behaviors in question are compared. The calculated performance value PW is higher the closer a response behavior of the test configuration data set LT is to the response behavior of the performance-optimized configuration data set LV.

Alternatively or additionally, a performance of the respective test configuration data set LT can also be determined by simulating the control behavior determined thereby through a simulation model of the technical system TS or its control device CTL for a plurality of time steps. This measures a cumulative reward or a cumulative return of the simulated behavior. A so-called surrogate model of the technical system TS is used here as a simulation model, which requires fewer computing resources than a detailed simulation.

The respective performance value PW determined for the respective test configuration data set LT is transmitted from the performance evaluator EVP to the Pareto optimizer OPTP. The transmitted performance value PW is used by the Pareto optimizer OPTP as fitness of the respective test configuration data set LT in terms of genetic programming. The performance evaluator EVP thus implements a performance-evaluating fitness function for the test configuration data sets LT.

Genetic programming generates a plurality of test configuration data sets LT with different levels of fitness. Through the performance-evaluating fitness function, genetic generation is preferentially driven towards performant configuration data sets. Nevertheless, multi-criteria optimization is performed using the deviation from the default configuration data set L0 as an independent optimization dimension.

The latter deviation is determined by the deviation evaluator EVD. As already indicated above, the deviation evaluator EVD determines a respective deviation value D for a respective test configuration data set LT, said deviation value D quantifying the deviation between the respective test configuration data set LT and the default configuration data set L0 and thus their similarity.

For example, the deviation value can be determined as a Euclidean distance in a vector space of a component representation of the configuration data sets LT and L0 as D=|LT−L0| or D=(LT−L0)². In the case of genetically encoded configuration data sets LT and L0, the deviation value D can be expressed by a number of differences in the genomes of the configuration data sets LT and L0, in particular, by a minimum number of operations necessary to convert the default configuration data set L0 to the test configuration data set LT. If the configuration data sets L0 and LT are coded as syntax trees, the deviation value D can be determined as the so-called tree edit distance.

Alternatively or additionally, a respective response behavior of the test configuration data set LT can also be compared with a response behavior of the default configuration data set L0 and, depending on this, the deviation value D can be calculated.

The deviation value D is transmitted from the deviation evaluator EVD to the Pareto optimizer OPTP. The Pareto optimizer OPTP determines a Pareto front PF within the generated test configuration data sets LT depending on the received deviation values D and performance values PW.

Finally, an optimized configuration data set LPO is selected from the resulting Pareto front PF. If necessary, predetermined selection criteria, in particular one or more further optimization criteria, can still be applied when selecting the optimized configuration data set LPO. By restricting the selection or a subsequent optimization to the Pareto front PF, the space of possible configurations is usually considerably reduced, with non-optimal configurations in particular being omitted. This considerably simplifies the selection of the optimized configuration data set LPO or even further optimizations.

The optimized configuration data set LPO is output as intended for configuring the control device CTL and/or transmitted directly to the control device CTL to configure it for optimized control of the technical system TS. The resulting configuration of the control device CTL leads to a control behavior that simultaneously exhibits both high performance and high user acceptance and/or safety. In addition, boundary conditions to be observed can be defined in a simple way by means of the specification EL.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for configuring a control device for a technical system the method comprising:
a) reading in a predefined default configuration data set for the control device;
b) generating a plurality of test configuration data sets;
c) for a respective test configuration data set;
determining a deviation value quantifying a deviation from the default configuration data set, and
determining a performance value quantifying a performance for controlling the technical system based on the respective test configuration data set,
d) performing a Pareto optimization for the plurality of test configuration data sets, wherein the deviation as well as the performance are used as Pareto objective criteria, and
e) selecting a configuration data set resulting from the Pareto optimization for configuring the control device.

2. The method according to claim 1, wherein data elements of the default configuration data set are selected, and
in that the test configuration data sets are generated on a basis of the default configuration data set, wherein a change to the selected data elements is suppressed.

3. The method according to claim 1, wherein
a Pareto front is determined by the Pareto optimization within the generated test configuration data sets, and
in that a configuration data set is selected from the Pareto front for configuring the control device.

4. The method according to claim 1, wherein
the Pareto optimization is performed by means of a genetic optimization method, a method of genetic programming, a gradient-based optimization method, a stochastic gradient method, a particle swarm optimization method, a Metropolis optimization method, and/or another machine learning method.

5. The method according to claim 1, wherein
new configuration data sets generated when performing the Pareto optimization are used as test configuration data sets.

6. The method according to claim 5, wherein the new configuration data sets are generated as part of performance-driven optimization.

7. The method according to claim 1, wherein
for determining the performance value for a respective test configuration data set, the technical system and/or a simulation model of the technical system is/are controlled on a basis of the respective test configuration data set and a resulting performance of the technical system is measured in the process.

8. The method according to claim 1, wherein
for determining the performance value for a respective test configuration data set, a deviation of a response behavior of the control device, configured with the respective test configuration data set, from a response behavior of the control device, configured with a performance-optimized configuration data set, is determined.

9. The method according to claim 5, wherein the performance-optimized configuration data set is determined by means of a method of reinforcement learning.

10. The method according to claim 1, wherein
for determining the deviation value for a respective test configuration data set, a deviation of a component representation of the respective test configuration data set from a component representation of the default configuration data set is determined.

11. The method according to claim 1, wherein
in order to determine the deviation value for a respective test configuration data set, a deviation of a response behavior of the control device, configured with the respective test configuration data set, from a response behavior of the control device, configured with the default configuration data set, is determined.

12. The method according to claim 1, wherein
the technical system is a traffic signal system, a turbine, a manufacturing system, a robot, a motor, another machine, another device or another system.

13. A configuration system for configuring a control device for a technical system, configured for carrying out the method according to claim 1.

14. A computer program product comprising a computer readable hardware storage device having computer readable program code stored therein, said program code executable by a processor of a computer system to implement a method according to claim 1.

15. The computer-readable storage medium comprising the computer program product according to claim 14.
